(19) United States
(12) Patent Application Publication
(10) Pub. No.: US 2016/0202072 A1
(43) Pub. Date: Jul. 14, 2016

(54) ELECTRONIC DEVICES FOR OUTPUTTING AND RECEIVING A LOCATION REFERENCE AND METHODS THEREFOR

(71) Applicant: Elektrobit Automotive GmbH, Erlangen (DE)

(72) Inventors: Martin Kunkel, Erlangen (DE); Christian Otto, Adelsdorf (DE)

(73) Assignee: Elektrobit Automotive GmbH, Erlangen (DE)

(21) Appl. No.: 14/989,426

(22) Filed: Jan. 6, 2016

(30) Foreign Application Priority Data
Jan. 14, 2015 (DE) 102015000470.0

(51) Int. Cl. G01C 21/30; G01C 21/26

(52) U.S. Cl. CPC G01C 21/30; G01C 21/265

(57) ABSTRACT

An electronic device for outputting a location reference using an attribute value which is assigned to a location to be referenced is provided, wherein the device comprises a memory, a processor system and a data transmission unit. The memory serves for storing and providing a list with attribute values for location referencing, the list consisting of a subset of all attribute values depending on a frequency of the individual attribute values. The processor system is adapted to receive an indication of a location, to determine at least one attribute value which is suitable for location referencing of the location, and for reading out, from the memory, an index value which is assigned to the determined attribute value in the list. The data transmission unit serves for outputting the read-out index value to a further device. Furthermore, an electronic device for receiving and evaluating a location reference using an attribute value which is assigned to a location to be referenced, and corresponding methods, are provided.

### TECHNICAL FIELD

The present disclosure relates to an electronic device and to a method for outputting a location reference using an attribute value which is assigned to a location to be referenced. Furthermore, the present disclosure relates to an electronic device and to a method for receiving and evaluating a location reference using such an attribute value, and to a computer-readable storage medium with computer-executable instructions for carrying out one of the methods.

### BACKGROUND

In the field of map- and location-based applications there are a large number of different device types. These range from navigation systems in vehicles to devices to be worn on the wrist, which have a GPS-based route recording function. Owing to this large number of device types and different applications, there is provision for being able to exchange location-based data between the devices and applications. Such an exchange of location data is also called location referencing. The obviously simplest variant of a location referencing is the transmission of location coordinates, for example in the coordinate system WGS84 (World Geodetic System 1984). However, despite use of a global positioning system (e.g. GPS—Global Positioning System), the exchange of location coordinates is not always accurate enough. Inaccuracies and errors arise due to measuring inaccuracies or different processing and calculation methods of the corresponding device, but also due to interference on receiving the satellite signals. Thus, in built-up areas, determination of inaccurate locations may occur, since the satellite signals are deflected or reflected by house façade, windows etc. If then not only a single location is to be referenced and transmitted from one device to another, for example the transmission of an entire route, a chain of inaccurate location referencings occurs. A further aspect is the location referencings between devices or applications which are based on different map materials. If the underlying map material does not correspond exactly to the measured coordinates, it can happen that a particular location referencing is not assigned to the same location in another map material without specifying further attributes. Merely by way of example, the specifying of a particular location on a multi-lane road is mentioned here. If then only the coordinates according to WGS84 are transmitted to another device with different map material, the location referencing there may be on a lane in the opposite direction. Similar problems arise also if the map material is exchanged or updated on one and the same device and stored location referencings are used.

A change was therefore made such that not only coordinates are transmitted, but also a reference to the environment of the location to be referenced is established. Besides the WGS84 coordinates, accordingly traffic network-specific attributes, such as class of road, cardinal direction of the corresponding road section and/or traffic direction, are also included in the transmission. A known standard for the transmission of such specific attributes is the AGORA-C Standard (ISO 17572-3). A further known transmission method takes place according to Standard SAE 32735 (DSRC—Dedicated Short Range Communications).

Despite the use of these transmission standards for location referencing, it may in some situations not be sufficient to reference a location by WGS84 coordinates, a class of road and a cardinal direction of the course of the road. If there is a plurality of roads running parallel to one another and close together, these location referencings too may lead to incorrect locations on another device or a device with updated map data.

### BRIEF SUMMARY

Therefore, electronic devices and methods for improving a location referencing using attributes are to be provided.

According to a first aspect of the present disclosure, an electronic device for outputting a location reference using an attribute value which is assigned to a location to be referenced is specified. The device comprises a memory for storing and providing a list with attribute values for location referencing, the list consisting of a subset of all attribute values depending on a frequency of the individual attribute values. Furthermore, the device comprises a processor system for receiving an indication of a location, for determining at least one attribute value which is suitable for location referencing of the location, and for reading out, from the memory, an index value which is assigned to the determined attribute value in the list. The device also comprises a data transmission unit for outputting the read-out index value to a further device. The further device can likewise be an electronic device which can determine a location, based on the outputted index value, in order to output this location for example on a display.

Each index value assigned to an attribute value can be a numerical index value and be represented by a bit sequence. The bit sequence can comprise a number of bits necessary for representing all index values of the list (and e.g. be limited to this number). The data transmission unit in this case outputs the index value in the form of the bit sequence to the further device. For example, the bit sequence can have a predetermined length, i.e. be limited to a predetermined number of bits. The bit sequence can have a fixed length of, for example, 8, 16, 24 or 32 bits. Other bit sequences are, of course, also possible.

The subset of all attributes depending on a frequency of the individual attribute values can comprise, according to the present disclosure, all those attribute values which occur most frequently among all possible attribute values (e.g. with regard to all locations referenceable in a particular region or at all). In the case of a predetermined bit sequence length for the index value, the bit sequence length also determines the number of possible attribute values in the list. The attribute values included in the list can be selected depending on their respective frequency from all attribute values. Preferably, the most frequently occurring attribute values form the subset stored in the list. Thus, “depending on a frequency” can mean that a predetermined number of the most frequently occurring attribute values form the subset.

Also “depending on a frequency” can mean that the attribute values forming the subset constitute a predetermined proportion of the most frequent attribute values. For example, 1%, 5%, 10%, 20% etc. of the most frequent attribute values form the subset. The size of the subset and thus the length of the bit sequence necessary for the index values is determined accordingly by the predetermined proportion.

Furthermore, the size of the subset can also be determined based on the frequency of the individual attribute values among all attribute values. In this case, “depending on a frequency” can mean that the attribute values, having at least a predetermined frequency among all attribute values, form the subset. The frequency of each attribute value considered can therefore lie in a range which is limited by the predetermined frequency. For example, the subset is formed by attribute values whose frequency among all attribute values is at least 0.1%, 0.2% or 0.3% etc. In other words, the attribute value occurs at at least 0.1%, 0.2% or 0.3% etc. among all attribute values. Here too the bit sequence length for representing all index values is determined by the number of the attribute values in the subset which are to be indexed.

In the present disclosure, “among all attribute values” means a predetermined set of attribute values which are considered for location referencing. Besides the universal set, i.e. all attribute values, it is also possible to consider only a subset. This can be firstly determined based on one or more criteria. For the frequency consideration the set of all attribute values can thus be reduced by means of one or more criteria. For example, all attribute values of a particular spatial region can form the basis for the frequency determination of the attribute values. By way of example, reference is made here to all street names or similar address-based attribute values of a country, federal state or other geographical region. It is also possible to determine the subset of the attribute values by other criteria, such as, for example, streets of a predetermined minimum length or places with a predetermined minimum number of inhabitants.

Alternatively to the bit sequence of fixed length for all attribute values of the list, the index values in the list can also have a variable length. In order to ensure data transmission which is as efficient as possible, in this case the most frequently occurring attribute value is outputted with the index value with the shortest bit sequence. Consequently, the list with attribute values is indexed according to their frequency within all (considered) attribute values. This can take place by a previous sorting of the attribute values according to their frequency. By such a variable bit sequence length, the data volume to be outputted can be optimised. However, this requires additional data which marks the beginning and/or the end of the bit sequence within the outputted data.

Additionally or alternatively, each attribute value can comprise at least one character string. For example, the character string can be a street name or can contain a street name. Thus, a reference attribute which represents a very clear identification of a location can be outputted with little data. Alternatively or additionally, further attributes such as a place name, a sight (a so-called point of interest (POI)), an identification of a motorway exit or the like can be outputted.

Additionally or alternatively to the above-mentioned implementation variants of the electronic device, the memory can be further adapted to store and provide a plurality of lists. Each list comprises attribute values for a particular referencing attribute. Moreover, the further lists too contain only attribute values which occur with a predetermined frequency among all attribute values of the corresponding referencing attribute.

According to a further implementation variant, the memory can further be adapted to store and provide a map with map elements, and an attribute value of at least one referencing attribute for at least one map element. The map elements comprise traffic route data which represents a traffic route network. Furthermore, the map elements can serve for a graphical display of a map.

For an improved location referencing, for each map element, which as described above has one or more locations which are difficult to reference, at least one attribute value of at least one referencing attribute can be stored. For example, for a map element a particular street name, place name etc. can be stored.

Additionally or alternatively thereto, the processor system can be adapted to determine a map element which is assigned to the location, and to determine the at least one attribute value based on the determined map element. The determining of the map element and/or the determining of the at least one attribute value can take place by accessing the memory or retrieving a particular map element or attribute value from the memory.

According to a further implementation variant, the electronic device can also comprise an interface for receiving position data. This interface, also called a position interface, serves for connecting a position detection device. A position detection device can comprise a sensor for satellite-supported navigation (e.g. GPS sensor), GPS processor (or the like), steering angle sensor, speed sensor or other position-determining sensors and corresponding processor systems for calculating a location.

In a particular implementation, the electronic device is a navigation device. This can be a navigation device which is permanently installed in a vehicle. Alternatively thereto, it can be a mobile navigation device. Likewise alternatively thereto, the electronic device can also be a vehicle infotainment device. The vehicle infotainment device can also be a mobile device or a device permanently installed in a vehicle. Furthermore, the electronic device can also be implemented in the form of another mobile terminal device, such as, for example, a smartphone, personal digital assistant (PDA), tablet computer, laptop computer, a device to be worn on the body (so-called wearable) etc.

In another implementation, the electronic device is a central server which is connected to at least one further electronic device via a data transmission channel. Such a central server can be operated by a service provider for traffic services, map materials, route determinations, etc. For example, a service provider can output current traffic reports, i.e. the traffic conditions at particular locations, to a large number of electronic devices. Such services are known as so-called “traffic jam reporters”.

According to a second aspect of the present disclosure, an electronic device for receiving and evaluating a location reference using an attribute value which is assigned to a location to be referenced is disclosed. Such a device can comprise a memory for storing and providing a list with attribute values for location referencing. The electronic device further comprises a data transmission unit for receiving an index value from a further device, and a processor system which is adapted to read out, from the memory, an attribute value which is assigned in the list to the received index value, and to determine a location which is referenced by the read-out attribute value.

Of course, this list can also consist of a subset of all attribute values depending on a frequency of the individual attribute values. Compared with the list of the electronic device according to the first aspect, the list of this electronic device (according to the second aspect) can have the same, more or even all attribute values of the corresponding referencing attribute. However, this list must comprise at least the subset according to the first aspect. For this second aspect of the present disclosure too, the memory can further be adapted to store and provide a map with map elements and an attribute value of at least one referencing attribute for at least one map element. As a result, a map consisting of at least one map element can be represented or displayed, which map can be referenced based on attribute values from the list.

Additionally, the electronic device further comprises a display device which is adapted to display a map. In this case, the processor system is further adapted to
determine a map element which is assigned to the location, and to control the display device for displaying a map which contains at least the determined map element.

According to an implementation variant, the electronic device is a navigation device. The electronic device can alternatively also be implemented in another mobile or permanently installed device, such as, for example, a smartphone, tablet computer, laptop computer etc.

Alternatively thereto, the electronic device can also be a central server which is connected to at least one further electronic device via a data transmission channel. Such a central server can be operated by a service provider for traffic services, map materials, route determinations, etc. Additionally thereto, the electronic device can also be capable of determining and outputting location referencings according to the first aspect. Thus, a referenced location, for example a traffic jam report, can be passed on from one mobile device to at least one other device.

According to a third aspect of the present disclosure, a method for outputting a location reference using an attribute value which is assigned to a location to be referenced is disclosed. To that end, the method comprises a storing of a list with attribute values for location referencing, the list consisting of a subset of all attribute values depending on a frequency of the individual attribute values. Furthermore, the method comprises a receiving of an indication of a location, a determining of at least one attribute value which is suitable for location referencing of the location, a reading out of an index value which is assigned to the determined attribute value in the list, and an outputting of the read-out index value to an electronic device.

Additionally thereto, the method can comprise a generating of a bit sequence which represents the index value and comprises a number of bits necessary for representing all index values of the list. In this case, the outputting of the index value comprises an outputting of the generated bit sequence.

As already explained above with regard to the first aspect, the bit sequence can have a particular fixed length. Alternatively thereto, the bit sequence can also have a variable length. In this case, the outputting of the index value additionally comprises an outputting of data which marks the beginning and/or the end of the bit sequence. According to one implementation of this method, the determined attribute value can be a street name. Alternatively, the attribute value can be a place name, a sight or POI, a motorway exit identification etc.

According to a fourth aspect of the present disclosure, a method for receiving and evaluating a location reference using an attribute value which is assigned to a location to be referenced is disclosed. According to this aspect, the method comprises a storing of a list with attribute values for location referencing. Furthermore, the method comprises a receiving of an index value from an electronic device, a reading out of an attribute value which is assigned to the received index value in the list, and a determining of a location which is referenced by the read-out attribute value.

As already explained above with regard to the first and third aspect, this list too can consist of a subset of all attribute values depending on a frequency of the individual attribute values. The list according to the fourth aspect can, however, also comprise more or even all attribute values of the corresponding referencing attribute. This list must, however, comprise at least the subset according to the first/third aspect.

In an implementation variant, the method further comprises a storing of a map with map elements and a storing of at least one attribute value of at least one referencing attribute for at least one map element.

Alternatively or additionally thereto, the method comprises a determining of a map element which is assigned to the location, and a displaying a map which contains at least the determined map element.

According to a fifth aspect of the present disclosure, a computer-readable storage medium which contains computer-executable instructions is disclosed. The instructions, when they are executed by a processor of a computer, cause the computer to carry out one of the above-described methods.

### BRIEF DESCRIPTION OF THE FIGURES

Further aspects, advantages and details of the present disclosure will become apparent from the following description of the embodiments in conjunction with the figures, in which:

FIG. 1 shows a block diagram of an electronic device for outputting a location reference according to an exemplary embodiment;

FIG. 2 shows a block diagram of an electronic device for receiving and evaluating a location reference according to an exemplary embodiment;

FIG. 3 shows an example of a stored list with attribute values and assigned index values;

FIG. 4 shows a flow diagram of a method for outputting a location reference and for receiving and evaluating a location reference according to exemplary embodiments; and

FIG. 5 shows a location referencing with the aid of a map element or a map detail.

### DETAILED DESCRIPTION

The present disclosure is explained below by way of example with the aid of schematic block diagrams and flow diagrams. The technical teaching on which these diagrams are based can be implemented both in hardware and software or a combination of hardware and software. This also includes digital signal processors (DSP), application-specific integrated circuits (ASICs) and other switching and computing components.

The present disclosure provides the possibility of more precisely identifying a location to be referenced, in order to enable an improved location referencing between two devices. The described exemplary embodiments are also suitable for improving a location referencing between one and the same device on which different map materials are present or on which existing map material has been updated.

This is explained firstly with the example according to FIG. 5. The latter shows a detail of a traffic route network which can correspond to one or more map elements. In FIG. 5 a location as specified, for example, by a GPS sensor or processor is marked by a circle. The actual position, however, is on Lupinenweg at the place marked by “X”. As explained at the outset, the deviation shown in FIG. 5 can occur due to measuring errors, calculation inaccuracies or the like. In an associated electronic device, the marking of the current position on Lupinenweg can be shown correctly. For example, previously measured position data and a corresponding movement of the electronic device can be brought into line with a traffic route network via the so-called map-matching method.

If the current position of the device is now to be transmitted to a further device, in conventional systems only the WGS84 coordinates would be transmitted. Additionally, particular reference attributes relating to the position can also be transmitted. These include the orientation of the traffic route (Lupinenweg), marked as an arrow in FIG. 5, or a traffic direction of this street.

If this information is transmitted to a further device, it can be easy for the further device to determine and display the position on Heideweg at the place marked by an “X” shown in FIG. 5. As shown in FIG. 5, the position according to the WGS84 coordinates is closer to Heideweg, which has the same orientation as Lupinenweg. The same problem occurs when the map material of the receiving device differs from that of the transmitting device. In this case, a correct location reference for the first map material would be outputted, but it would be assigned to a different location in the second map material. By merely transmitting the coordinates and the cardinal direction orientation of Lupinenweg, the location referencing thus fails, since Heideweg would be identified as being the closer traffic route instead of Lupinenweg.

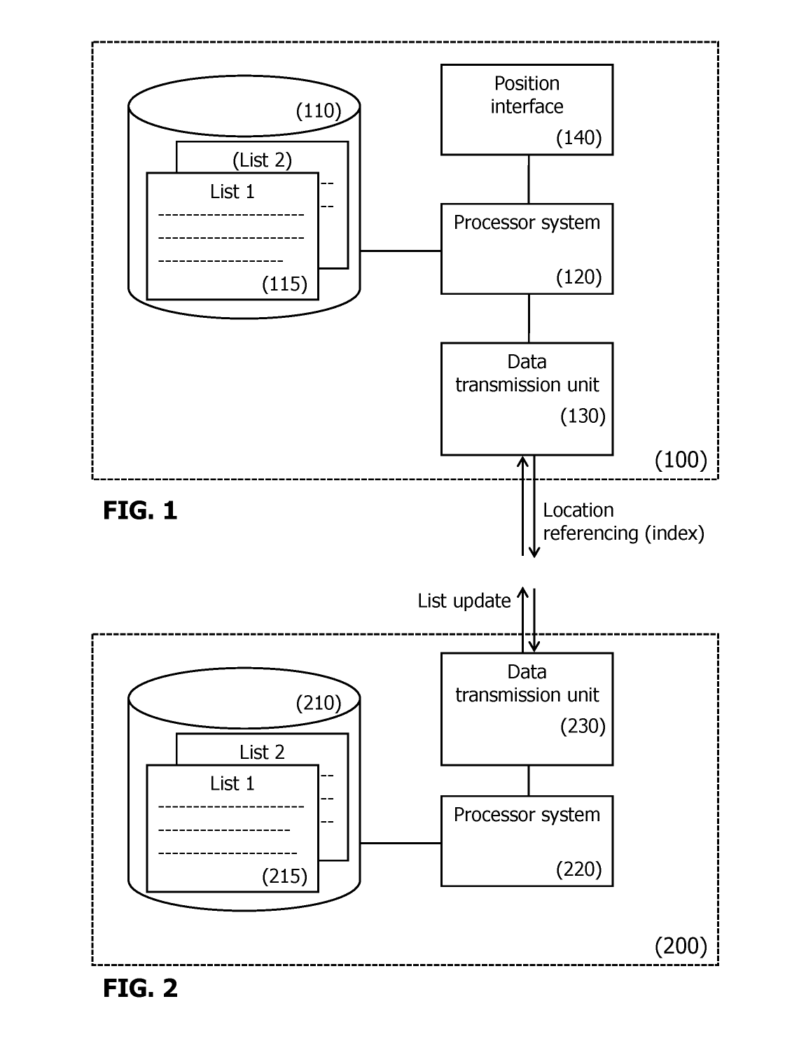

The present disclosure avoids this incorrect location referencing or at least significantly reduces the probability of an incorrect location referencing. FIG. 1 shows a configuration of an electronic device for outputting a location reference using an attribute value. The electronic device 100 comprises for this purpose a memory 110 for storing and providing a list 115 with attribute values for location referencing. The electronic device 100 further comprises a processor system 120, a data transmission unit 130 and optionally a position interface 140.

The electronic device 100 can be a navigation device, a vehicle infotainment device, a smartphone, a tablet computer, laptop computer or similar mobile device. Instead of a mobile device, the electronic device 100 can also be a stationary device which is permanently installed—for example in a vehicle. The device can also be a central server which outputs location referencings to a large number of other devices, for example a server of a traffic conditions service.

The memory 110 serves for storing at least one list 115. By way of example, two lists “List 1” and “List 2” are shown in FIG. 1. Each list contains attribute values for location referencing, that is to say attribute values which characterise a particular location, in order to reference the latter. The attribute values of a list relate to a particular referencing attribute. The “List 1” 115 comprises, for example, attribute values of the referencing attribute “street name”. Each attribute value in the list 115 corresponds to a street name. Further referencing attributes can be place names, sights (so-called POIs), junctions on motorways or other roads, and similar referencing attributes consisting of a sequence of letters.

A list 115 can comprise attribute values which fulfil a particular criterion. Examples mentioned here are street names which occur in a particular spatial region (such as Germany, a federal state or particular towns), or places with more than 500,000 inhabitants). To compile a list 115, all attribute values which fulfil the particular criterion are collected and evaluated. The collecting of attribute values is not limited to one criterion, but can also be limited by a predetermined data structure. Thus, only attribute values from one data base or other data structure associated with a location referencing application can be considered. Application- and device-specific lists can thus be generated. Of course, the compiling of a list 115 can also take place on the basis of all attribute values, i.e. without previous application of a filter criterion.

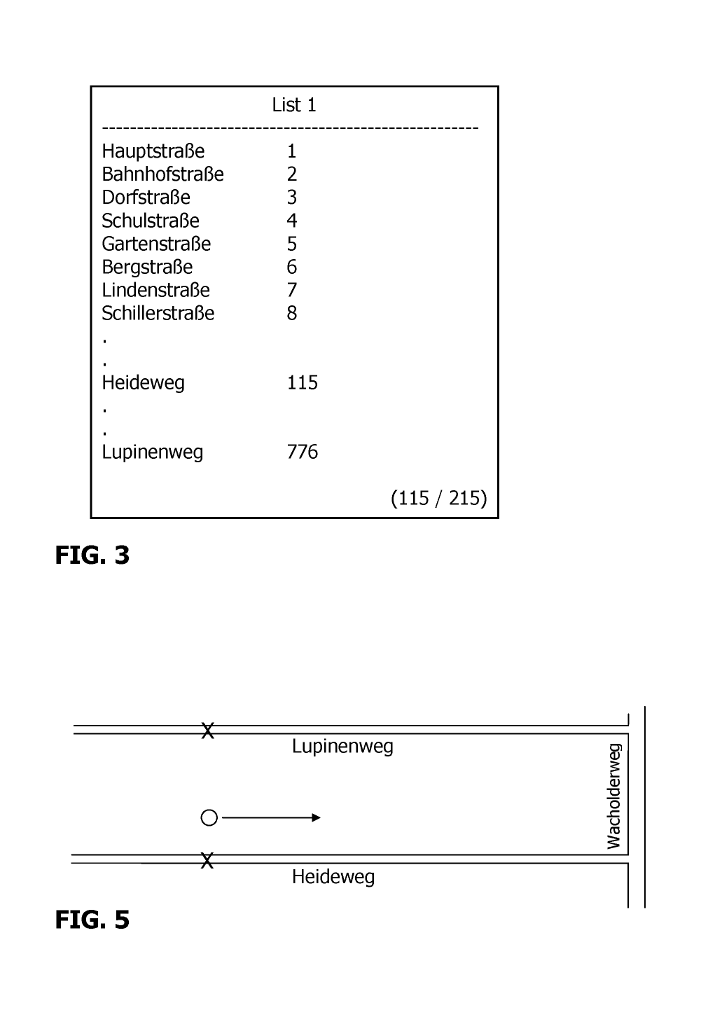

Furthermore, the list 115 consists not only of all attribute values considered, but a subset of all attribute values depending on a frequency of the individual attribute values. This means in the present disclosure that, of all attribute values, only particular attribute values are selected based on their frequency. Such a subset is shown, by way of example, in FIG. 3. In this case, the list 115 shown comprises for each attribute value (here street name) a unique index value in the list. For the compilation of the list, firstly the size of the subset, i.e. the number of attribute values in the list 115, is determined. Each index value assigned to an attribute value can be represented by a bit sequence. In this case, the bit sequence for each index value in the list 115 can have a predetermined length, i.e. be limited to a predetermined number of bits. For example, the bit sequence can have a fixed length of 8, 16, 24 or 32 bits for all index values. Other bit sequence lengths are, of course, also possible. Thus, the bit sequence length also determines the number of possible attribute values in the list, which therefore has 2^{bit sequence length} index value/attribute value pairs.

The attribute values (the subset) included in the list are selected from all attribute values depending on their respective frequency. In this case, the most frequently occurring attribute values form the subset stored in the list 115. Thus, “depending on a frequency” can mean that a number of the most frequently occurring attribute values which is determined by the bit sequence length form the subset.

For simpler explanation, the present disclosure is described below with the aid of a list 115 of street names in a particular spatial region, such as, for example, Germany. Of course, the present disclosure is not limited to this specific list 115. Other and/or further lists 115 based on different data bases and other referencing attributes can be compiled and used. For further clarification, the eight most frequent street names in Germany with their corresponding number and frequency (in %) are given in the following table.

TABLE 1
Germany's most frequent street names

| | | | Cumulative |
|---|---|---|---|
| Name | Number | Frequency | frequency |
| Hauptstraβe | 61013 | 1.10688% | 1.11% |
| Bahnhofstraβe | 29988 | 0.54403% | 1.65% |
| Dorfstraβe | 25412 | 0.46102% | 2.11% |
| Schulstraβe | 17187 | 0.31180% | 2.42% |
| Gartenstraβe | 16477 | 0.29892% | 2.72% |
| Bergstraβe | 14264 | 0.25877% | 2.98% |
| Lindenstraβe | 13389 | 0.24290% | 3.22% |
| Schillerstraβe | 13178 | 0.23907% | 3.46% |

If the bit sequence length is now set at two bits, the list 115 can comprise four indexed attribute values. For Germany these would be Hauptstraβe, Bahnhofstraβe, Dorfstraβe and Schulstraβe.

The size of the subset can also be determined based on the frequency of the individual attribute values among all attribute values. In this case, “depending on a frequency” can mean that those attribute values which have at least a predetermined frequency among all attribute values form the subset. The frequency of each attribute value considered can therefore lie in a range which is limited by the predetermined frequency. For example, the street names can form a subset whose frequency among all attribute values is at least 0.2%, 0.4% or 0.6% etc. In other words, the attribute value occurs at at least 0.2%, 0.4% or 0.6% etc. among all attribute values. In the example according to Table 1, this would be all stated street names (>0.2%), the Hauptstraβe to Schulstraβe (>0.4%) and only the Hauptstraβe (>0.6%). In this case, the bit sequence length for representing all index values is determined by the number of attribute values in the subset which are to be indexed.

On the other hand, the size of the subset (the number of attribute values in the list 115) could also be determined by a predetermined size of the frequency. Thus, “depending on a frequency” can also mean that the attribute values forming the subset constitute a particular proportion of the attribute values. For example, 1%, 5%, 10% or 20% of all attribute values can form the subset, with only the most frequent attribute values being taken into account. In the total set (i.e. all attribute values) sorted according to frequency this corresponds to the first 1%, 5%, 10% etc. of the elements of this total set. The length of the bit sequence required for the index values of the list 115 is determined, accordingly, likewise by the size of the resulting subset.

A further criterion for determining the subset can also be an absolute frequency and/or an absolute frequency range. For example, Hauptstraβe, Bahnhofstraβe and Dorfstraβe form a list 115 containing all street names which occur more than 20,000 times.

Since the list 115 is limited to attribute values depending on their frequency, the memory requirements and computing outlay which are required for this are kept within limits. At the same time, however, many location referencings become more precise. If, by contrast, all attribute values were available in a list and indexed therein, the memory and computing outlay would be comparatively large and the index value to be outputted relatively long. For example, in Germany there are far more than a million different street names, which thus requires an index with a bit sequence length of 21 bits. In other countries there are even more street names. It is therefore advantageous if the list 115 does not comprise all attribute values which occur in the underlying data material.

With reference to Table 1, 3.5% of the most frequent German street names can be covered with a bit sequence of only 4 bits long. With for example only 10 bits, 30% of the most frequent street names can be covered and with 13 bits even more than 54% of the most frequent street names. Moreover when using a bit sequence with a length of 10 bits the list 115 is only a little over 13,500 characters long (plus the data of the index values, and further data base-specific data). A table with approximately 13,500 characters has a size of about 50 KB. The memory requirements in the electronic device 100 are thus relatively low. In a list with an index of the bit sequence length of 13 bits, all street names listed in the list 115 would comprise a little over 115,500 characters.

Alternatively to the bit sequence with fixed length, the index values in the list 115 can have a variable length. To that end, the attribute values in the list 115 are sorted and subsequently indexed based on their frequency, with the most frequently occurring attribute value being provided with the index value with the shortest bit sequence. Consequently, the list 115 is indexed with attribute values according to their frequency within the attribute values (considered). This can also take place without previous sorting of the list 115. Then the algorithm used must read out the individual attribute values according to a descending frequency from the attribute values to be indexed and store them with indices of ascending bit sequence length. As a result of such a variable bit sequence length, the amount of data to be transmitted can be optimised. It must be taken into account here that this requires additional data which marks the beginning or at least the end of the bit sequence. In the case of a variable bit sequence length, it is also easily possible to include all attribute values in the list 115 if sufficient memory space is available in the electronic device 100. Thus, in each location referencing, an attribute value can be outputted/transmitted, whereby the location referencing becomes more precise. The outputted location referencing data will then on average turn out to be less, since small index values are outputted quite often owing to the frequency of the attribute values. Accordingly, the list 115 can be compiled with indices of fixed or variable bit sequence length, depending on the reference attribute.

Again with reference to FIG. 1 and also FIG. 3, the indexing of the subset of attribute values stored in the list 115 is advantageous in particular when each attribute value comprises a character string. The storage or transmission of a character string requires a much greater data volume than the storage or transmission of a preferably numerical index value.

The list 115 stored in the memory 110 is not regenerated for each location referencing, but has already been generated beforehand and can be used for a plurality of successive location referencings. The attribute values contained in the list 115 and their frequencies do not usually change as frequently as location referencings. On the one hand, the electronic device 100 can compile the list 115 itself, based on reference attributes stored in the memory 110. On the other hand, the list 115 can also be compiled by another device, for example a central server and transmitted to the electronic device 100.

In addition to the above-described configuration, the memory 110 shown in FIG. 1 can store and provide, in addition to the lists 115, also a map with map elements and an attribute value of at least one referencing attribute for at least one map element. Map elements and associated attribute values serve for displaying a map on a screen (not shown). The displaying of a map can comprise a displaying of an individual map element or a plurality of map elements. Depending on the size of the screen and depending on the desired level of detail, the map elements can contain varying amounts of graphical data and also associated attribute values.

The electronic device 100 further comprises a processor system 120 which can receive at least one indication of at least one location. The indication of a particular location can be received by a user input. For example, a user can select on a graphical surface a particular point or element in a map, which is passed on to the processor system 120. The user selection can take place by input means, such as keys, rotary wheels, mouse, touchscreen etc.

Alternatively or additionally thereto, the processor system 120 can also receive position data via an interface 140. This optional position interface 140 can be connected to a position sensor or other position detection system (not shown). For example, there can be connected to the position interface 140 a GPS sensor and/or GPS position detection system. From this the processor system 120 receives position data for a location. Subsequently, the processor system 120 can determine at least one attribute value which is suitable for the location referencing of the location. This attribute value can be determined with the aid of map elements. For this the processor system 120 can determine a map element which is assigned to the location or the position data. In other words the location or the position lies in a particular map element which the processor system 120 can determine. Starting from that, the processor system 120 determines at least one attribute value with the aid of the determined map element. The data on which the map element is based comprises referencing attributes relating to this map element. These include, besides particular coordinates (corner coordinates or centre coordinates of the map element), also traffic routes, traffic intersections, place names, region names, traffic directions, street names, house numbers, POIs etc. Of course, the determination of reference attribute(s) and corresponding attribute value(s) can also take place on the basis of data which does not comprise complete map data.

In an optional step the processor system can determine whether a found attribute value is associated with a referencing attribute for which a list 115 is stored in the memory 110. In this case, the processor system 120 reads out from the memory an index value which is assigned to the determined attribute value in the list 115.

Starting from the indicated location (e.g., the position data), the processor system 120 can accordingly determine attribute values for referencing attributes, and fetch a corresponding index value to the determined attribute value from the list 115.

Through transmission of the street name (by means of index value) the precision of the location referencing can be increased. Previous systems are designed to minimise the data to be transmitted in a location referencing. The transmission of character strings, which can be transmitted (for example by means of ASCII code) only with a comparatively high data volume, was therefore excluded. The present disclosure improves the location referencing in a simple way by transmitting a (numerical) index value instead of a complete character string.

In the case where for a location there is determined a referencing attribute and attribute value for which no list 115 at all is stored or which does not occur in the list 115, a conventional location referencing takes place without an indexed attribute value, as explained at the outset. As a result, although location referencings still lead to incorrect results, this only happens for the attribute values which occur less frequently. Overall, however, better location referencings are achieved by the present disclosure.

The processor system 120 outputs the location referencing via a data transmission unit 130 optionally contained in the electronic device 100. The index value read out from the list 115 is also associated with this location referencing. The data transmission unit 130 puts the location referencing data provided by the processor system 120 into a format which can be transmitted to at least one other device. Alternatively to the above-described procedure, the data transmission unit 130 can also read out from the list 115, with the aid of an attribute value determined by the processor system 120, the corresponding index value or the associated bit sequence and insert it into the data to be transmitted, in accordance with the data transmission format.

Of course, the location referencing data does not have to be outputted for transmission to another device. As already stated above, the location referencing also serves for the interaction of different applications on a device or for transmitting locations between different map materials. The data transmission unit 130 is capable of outputting the location referencing data for each of these purposes accordingly.

The location referencing data (to be transmitted) thus generated has the advantage over conventional systems that it enables a more precise location referencing. In the example of FIG. 5, the position of the electronic device 100 can be outputted, with the aid of the outputted index value for Lupinenweg, correctly at the place on Lupinenweg marked by an X.

With reference to FIG. 2 there is now explained an electronic device 200 for receiving and evaluating a location reference using an attribute value assigned to a location to be referenced. The electronic device 200 likewise comprises a memory 210 for storing and providing a list 215 with attribute values for location referencing. The list 215 is compiled in exactly the same way as the list 115 of the electronic device 100 (see FIG. 1). Moreover, the list 215 contains at least the same attribute values and associated index values as the list 115. In an implementation variant the list 215 can also comprise all attribute values of the corresponding referencing attribute.

Besides a processor system 220 the electronic device 200 also comprises a data transmission unit 230. With the data transmission unit 230 the electronic device 200 receives an index value from a further device, such as, for example, the electronic device 100 (FIG. 1). The received index value is a piece of data or information which is received for a location referencing. The received data corresponds to the data outputted by the data transmission unit 130 described above with reference to FIG. 1.

The processor system 220 is further adapted to read out from the memory 210 an attribute value which is assigned in the list 215 to the received index value. In addition, the processor system 220 determines a location which is referenced by the read-out attribute value. The location or position can also be determined by including further information, such as received coordinates or further attribute values.

As already explained with respect to the electronic device 100 (FIG. 1), the memory 210 of the electronic device 200 (FIG. 2) can also store and provide a map with map elements. Furthermore, the memory 210 can store an attribute value of at least one referencing attribute for at least one map element and provide it to other components of the electronic device 200.

Of course, further lists 215 (“List 1”, “List 2” etc.) can also be stored in the memory 210. In this case, each list comprises attribute values of a particular referencing attribute for location referencing which constitute a subset of all attribute values depending on the frequency of the attribute values.

Owing to the location referencing including the above-described index value, it is possible for the electronic device 200 (or the processor system 220) to better determine the referenced location. According to the example of FIG. 5 and the list according to FIG. 3, the data transmitted by the electronic device 100 to the further electronic device 200 also comprises the index value 776 associated with Lupinenweg. The electronic device 200 now has an orientation referencing (e.g. including coordinate data and an orientation of the traffic path) and also an index value associated with the street name to be referenced. Thus, the electronic device 200 or the processor system 220 can determine a location which is not situated on the closer Heideweg, but on the correct Lupinenweg (see places marked by “X” in FIG. 5).

In the case where the electronic device 200 comprises a display device (not shown), a map which includes the referenced location or the position can be displayed. To that end, the processor system 220 can determine a map element which is assigned to the location which was determined from the received data including the received index value. The processor system 220 can also control the display device in a manner suitable for displaying a map containing at least the determined map element. Such a display is found in a navigation device or other mobile device (smartphone, tablet computer, laptop computer, GPS tracking system, etc.). The electronic device 200 does not necessarily have to be a device with a display device for displaying map data. The electronic device 200 can also be a central server which is connected to at least one further electronic device 100 via a data transmission channel. This server can be a server of a traffic conditions service (“traffic server”). The electronic device 200 can therefore also comprise the functionality of the electronic device 100, in order to reference (pass on) received or otherwise obtained locations to a large number of devices. By way of example, the reception of a traffic jam report, and the passing on of location referencings relating to the traffic jam report to many devices, are cited here.

As already explained, the list 115/215 must be stored both on the electronic device 100 and the electronic device 200. The lists 115/215 must correspond for a correct location referencing. This can be accomplished by a simple version management. If the electronic device 200 is a central server, updated lists (“List updates”) can be transmitted to one or more electronic devices 100 at regular intervals.

Alternatively, the electronic device 100 can also initiate a version comparison of the list 115/215 at time intervals or before the transmission of a location referencing in the electronic device 200. Only if the lists 115/215 no longer correspond (a list is thus out of date) can a list update be carried out.

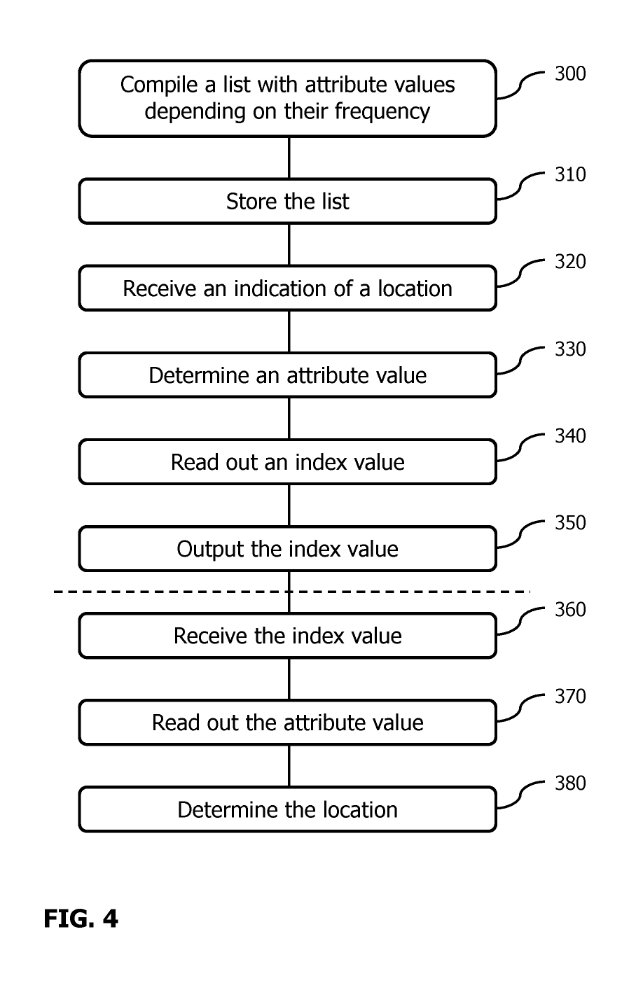

With reference to FIG. 4, the present disclosure is summarised again with the aid of a corresponding method sequence. The method begins with the compiling of a list with attribute values depending on their frequency (step 300). The attribute values are collected from all attribute values of a particular data set (and possibly also based on a particular criterion, particular map elements, the entire data base, a particular spatial region etc.). Subsequently, the frequency of at least one attribute value within the determined attribute values is calculated.

In a further step 310 the list with the subset of all attribute values is stored. For each attribute value the list also contains a particular index value. This index value is unique within the list. In one configuration the compiling of a list is already limited, by a length of a bit sequence which is necessary for representing the index value, to a corresponding number of list entries.

Such a list has to be stored on at least one electronic device. If the location referencing takes place between two applications on the same electronic device, it is sufficient for the list to be stored on one electronic device. If the location referencing takes place, however, between two devices, each device has to store the list.

A location referencing begins thereafter in step 320 by receiving an indication of a location. The indication of the location can be a coordinate input by suitable sensors. The indication of the location can also take place by a user input, for example on a map.

In a step 330, based on the received location, an attribute value which is suitable for location referencing of the location is determined. Subsequently, in step 340 an index value is read out from the list explained above. The index value is subsequently outputted in step 350. The outputting can comprise the transmission of the index value to another device or a temporary storage on the same device. Besides the index value, usually also further information, such as, for example, coordinate data (e.g. WGS84 coordinates) and/or further reference attributes and/or further index values of other reference attributes are outputted.

As shown in FIG. 4 by the dashed line, the location referencing method is now continued at another place. This can be another electronic device. The method can, however, also be continued on the same electronic device, if the location referencing takes place between different map applications, map data, etc.

In any case, the above-described outputted index value (and possibly also further information and data relating to the location referencing) is received in step 360. Based on the index value, in step 370 an attribute value can be read out from the above-mentioned list.

Finally, in step 380 a location is determined using the read-out attribute value. Besides the attribute value, the further transmitted data (coordinates etc.) can also be used to determine the location.

Owing to the transmission of an index value comprising an attribute value, such as, for example, a character string (street name, place name, etc.), the location can be determined in step 380 much more precisely than was possible hitherto.

The above-stated examples, referencing attributes and value ranges serve solely for explaining the present disclosure. The disclosure is not intended to be restricted to these examples, referencing attributes and value ranges. Rather, the scope of the present disclosure is defined by the following claims.

1. Electronic device for outputting a location reference using an attribute value which is assigned to a location to be referenced, wherein the device comprises:
a memory for storing and providing a list with attribute values for location referencing, the list consisting of a subset of all attribute values depending on a frequency of the individual attribute values;
a processor system which is adapted to
receive an indication of a location,
determine at least one attribute value which is suitable for location referencing of the location, and
read out, from the memory, an index value which is assigned to the determined attribute value in the list; and
a data transmission unit for outputting the read-out index value to a further device.

2. Electronic device according to claim 1, wherein each index value assigned to an attribute value is a numerical index value and is represented by a bit sequence which comprises a number of bits necessary for representing all index values of the list, and wherein the data transmission unit transmits the index value in the form of the bit sequence to the further device.

3. Electronic device according to claim 1, wherein each attribute value comprises at least one character string.

4. Electronic device according to claim 3, wherein the character string is a street name or contains a street name.

5. Electronic device according to claim 1, wherein the memory is further adapted to store and provide a plurality of lists, each list comprising attribute values for a particular referencing attribute.

6. Electronic device according to claim 1, wherein the memory is further adapted to store and provide
a map with map elements, and
an attribute value of at least one referencing attribute for at least one map element.

7. Electronic device according to claim 1, wherein the processor system is further adapted to
determine a map element which is assigned to the location, and
determine the at least one attribute value based on the determined map element.

8. Electronic device according to claim 1, further comprising:
an interface for receiving position data.

9. Electronic device according to claim 1, wherein the electronic device is a navigation device.

10. Electronic device according to claim 1, wherein the electronic device is a vehicle infotainment device.

11. Electronic device for receiving and evaluating a location reference using an attribute value which is assigned to a location to be referenced, wherein the device comprises:
a memory for storing and providing a list with attribute values for location referencing;
a data transmission unit for receiving an index value from a further device;
a processor system which is adapted to
read out, from the memory, an attribute value which is assigned in the list to the received index value, and
determine a location which is referenced by the read-out attribute value.

12. Electronic device according to claim 11, wherein the memory is further adapted to store and provide
a map with map elements, and
an attribute value of at least one referencing attribute for at least one map element.

13. Electronic device according to claim 12, wherein the electronic device further comprises:
a display device which is adapted to display a map,
wherein the processor system is further adapted to
determine a map element which is assigned to the location, and
control the display device for displaying a map which contains at least the determined map element.

14. Electronic device according to claim 11, wherein the electronic device is a navigation device.

15. Electronic device according to claim 11, wherein the electronic device is a central server which is connected to at least one further electronic device via a data transmission channel.

16. Method for outputting a location reference using an attribute value which is assigned to a location to be referenced, wherein the method comprises:
storing a list with attribute values for location referencing, the list consisting of a subset of all attribute values depending on a frequency of the individual attribute values;
receiving an indication of a location;
determining at least one attribute value which is suitable for location referencing of the location;
reading out an index value which is assigned to the determined attribute value in the list; and
outputting the read-out index value to an electronic device.

17. Method according to claim 16, wherein the method further comprises:
generating a bit sequence which represents the index value and comprises a number of bits necessary for representing all index values of the list, wherein the outputting of the index value comprises an outputting of the generated bit sequence.

18. Method according to claim 16, wherein the determined attribute value is a street name.

19. Method for receiving and evaluating a location reference using an attribute value which is assigned to a location to be referenced, wherein the method comprises:
storing a list with attribute values for location referencing;
receiving an index value from an electronic device;
reading out an attribute value which is assigned to the received index value in the list; and
determining a location which is referenced by the read-out attribute value.

20. Method according to claim 19, further comprising:
storing a map with map elements; and
storing at least one attribute value of at least one referencing attribute for each map element.

21. Method according to claim 20, further comprising:
determining a map element which is assigned to the location; and
displaying a map which contains at least the determined map element.

22. Computer-readable storage medium which contains computer-executable instructions which, when they are executed by a processor of a computer, cause the computer to carry out the method according to claim 16.

23. Computer-readable storage medium which contains computer-executable instructions which, when they are executed by a processor of a computer, computer to carry out the method according to claim 19.
